(19) United States
(12) Patent Application Publication
(10) Pub. No.: US 2024/0380730 A1
(43) Pub. Date: Nov. 14, 2024

(54) ENABLING DISTRIBUTED NON-ACCESS STRATUM TERMINATIONS

(71) Applicant: NOKIA TECHNOLOGIES OY, Espoo (FI)

(72) Inventors: Horst Thomas BELLING, Erding (DE); Bruno LANDAIS, Pleumeur-Bodou (FR); Devaki CHANDRAMOULI, Plano, TX (US); Laurent THIEBAUT, Antony (FR)

(21) Appl. No.: 18/696,707

(22) PCT Filed: Sep. 28, 2021
(86) PCT No.: PCT/US2021/052410

§ 371 Date: Mar. 28, 2024

(51) Int. Cl. H04L 61/5038; H04L 61/5053; H04L 101/654; H04W 12/041; H04W 48/18

(52) U.S. Cl. CPC H04L 61/5038; H04L 61/5053; H04W 12/041; H04W 48/18; H04L 2101/654

(57) ABSTRACT

Techniques for providing distributed NAS layer termination points within a communication network. A network entity assigns a non-access stratum temporary identifier to a user device. The non-access stratum temporary identifier is associated with a non-access stratum termination point, and wherein a type of non-access stratum termination point is based at least in part on an apparatus type configured to handle one or more non-access stratum messages. The network entity causes the user device to be provided with the non-access stratum temporary identifiers.

### TECHNOLOGICAL FIELD

An example embodiment relates generally to wireless communications and, more particularly, but not exclusively, to enabling distributed non-access stratum terminations in communication networks.

### BACKGROUND

Next generation or fifth generation (5G) technology was designed to provide high capacity mobile multimedia with high data rates and is intended to be used not only for human interaction, but also for machine type communications in so-called Internet of Things (IoT) networks. Sixth generation (6G) technology further builds off 5G technology to provide high yield increased processing speeds.

### BRIEF SUMMARY

A method, apparatus, and computer program product are disclosed for enabling distributed non-access stratum terminations in communication networks. Such non-access stratum terminations may enable terminations and/or the introduction of direct communication between a radio access network and the network functions in the core network. As such, such distributed non-access stratum terminations may improve communication networks by reducing signaling latency, reducing computational resources expended by core network functions, and improving overall network security by enabling containers to be carried to a user device in an encrypted manner using the distributed non-access stratum termination layers.

In an example embodiment, a method is provided that includes assigning a non-access stratum temporary identifier to a user device, wherein the non-access stratum temporary identifier is associated with a non-access stratum termination point, and wherein a type of non-access stratum termination point is based at least in part on an apparatus type configured to handle one or more non-access stratum messages. The method may further include causing the user device to be provided with the non-access stratum temporary identifiers.

The method may further include receiving, from the user device, a non-access stratum message, wherein the received non-access stratum message corresponds to a non-access stratum message type associated with the apparatus type.

The method may further include terminating non-access stratum security that is dedicated to the non-access stratum connection between the user device and the said non-access stratum termination point.

The method may further include generating one or more security keys dedicated to the said non-access stratum termination point from one or more baseline non-access stratum security keys.

The method may further include receiving a non-access stratum message from the user device, wherein the non-access stratum message is associated with a non-access stratum termination point which does not correspond to the apparatus. The method may further include selecting an appropriate network function supporting said non-access stratum termination point based at least in part on the received non-access stratum message.

The method may further include causing the appropriate network function to be provided with one or more non-access stratum security keys to be used for a non-access stratum security that is dedicated to the non-access stratum connection between the user device and the said non-access stratum termination point.

The method may further include in an instance in which one or more baseline non-access stratum keys have changed, causing the appropriate network function to be provided with the one or more updated security keys to be used for the non-access stratum security that is dedicated to the non-access stratum connection between the user device and the said non-access stratum termination point. The method may further include causing the appropriate network function to be provided with one or more security keys corresponding to one or more baseline non-access stratum security keys

In some embodiments, the non-access stratum temporary identifier allows the apparatus to uniquely identify a set of network functions that share context data related with network services provided to the user device's, and to uniquely identify the user device's non-access stratum context. In some embodiments, the non-access stratum termination point comprises an access and mobility management function or session management function. In some embodiments, the non-access stratum temporary identifier identifies an apparatus set in which all apparatus in the apparatus set have access to the same context associated with the non-access stratum termination point. In some embodiments, the non-access stratum temporary identifier identifies a specific apparatus in the apparatus set. In some embodiments, the non-access stratum temporary identifier identifies a group of apparatus sets.

In an example embodiment, an apparatus is provided with means for assigning a non-access stratum temporary identifier to a user device, wherein the non-access stratum temporary identifier is associated with a non-access stratum termination point, and wherein a type of non-access stratum termination point is based at least in part on an apparatus type configured to handle one or more non-access stratum messages. The apparatus may further include means for causing the user device to be provided with the non-access stratum temporary identifiers.

The apparatus may further include means for receiving, from the user device, a non-access stratum message, wherein the received non-access stratum message corresponds to a non-access stratum message type associated with the apparatus type.

The apparatus may further include means for terminating non-access stratum security that is dedicated to the non-access stratum connection between the user device and the said non-access stratum termination point.

The apparatus may further include means for generating one or more security keys dedicated to the said non-access stratum termination point from one or more baseline non-access stratum security keys.

The apparatus may further include means for receiving a non-access stratum message from the user device, wherein the non-access stratum message is associated with a non-access stratum termination point which does not correspond to the apparatus. The apparatus may further include means for selecting an appropriate network function supporting said non-access stratum termination point based at least in part on the received non-access stratum message.

The apparatus may further include means for causing the appropriate network function to be provided with one or more non-access stratum security keys to be used for a non-access stratum security that is dedicated to the non-access stratum connection between the user device and the said non-access stratum termination point.

The apparatus may further include means for, in an instance in which one or more baseline non-access stratum keys have changed, causing the appropriate network function to be provided with the one or more updated security keys to be used for the non-access stratum security that is dedicated to the non-access stratum connection between the user device and the said non-access stratum termination point. The apparatus may further include means for causing the appropriate network function to be provided with one or more security keys corresponding to one or more baseline non-access stratum security keys

In some embodiments, the non-access stratum temporary identifier allows the apparatus to uniquely identify a set of network functions that share context data related with network services provided to the user device's, and to uniquely identify the user device's non-access stratum context.

In some embodiments, the non-access stratum termination point comprises an access and mobility management function or session management function. In some embodiments, the non-access stratum temporary identifier identifies an apparatus set in which all apparatus in the apparatus set have access to the same context associated with the non-access stratum termination point. In some embodiments, the non-access stratum temporary identifier identifies a specific apparatus in the apparatus set. In some embodiments, the non-access stratum temporary identifier identifies a group of apparatus sets.

In an example embodiment, an apparatus is provided including at least one processor and at least one memory including computer program code with the at least one memory and the computer program code configured to, with processing circuitry, cause the apparatus at least to assign a non-access stratum temporary identifier to a user device, wherein the non-access stratum temporary identifier is associated with a non-access stratum termination point, and wherein a type of non-access stratum termination point is based at least in part on an apparatus type configured to handle one or more non-access stratum messages. The at least one memory and the computer program code may further be configured to, with processing circuitry, cause the apparatus at least to cause the user device to be provided with the non-access stratum temporary identifiers.

The at least one memory and the computer program code may further be configured to, with processing circuitry, cause the apparatus at least to receive, from the user device, a non-access stratum message, wherein the received non-access stratum message corresponds to a non-access stratum message type associated with the apparatus type.

The at least one memory and the computer program code may further be configured to, with processing circuitry, cause the apparatus at least to terminate non-access stratum security that is dedicated to the non-access stratum connection between the user device and the said non-access stratum termination point.

The at least one memory and the computer program code may further be configured to, with processing circuitry, cause the apparatus at least to generate one or more security keys dedicated to the said non-access stratum termination point from one or more baseline non-access stratum security keys.

The at least one memory and the computer program code may further be configured to, with processing circuitry, cause the apparatus at least to receive a non-access stratum message from the user device, wherein the non-access stratum message is associated with a non-access stratum termination point which does not correspond to the apparatus. The at least one memory and the computer program code may further be configured to, with processing circuitry, cause the apparatus at least to select an appropriate network function supporting said non-access stratum termination point based at least in part on the received non-access stratum message.

The at least one memory and the computer program code may further be configured to, with processing circuitry, cause the apparatus at least to cause the appropriate network function to be provided with one or more non-access stratum security keys to be used for a non-access stratum security that is dedicated to the non-access stratum connection between the user device and the said non-access stratum termination point. The at least one memory and the computer program code may further be configured to, with processing circuitry, cause the apparatus at least to, in an instance in which one or more baseline non-access stratum keys have changed, cause the appropriate network function to be provided with the one or more updated security keys to be used for the non-access stratum security that is dedicated to the non-access stratum connection between the user device and the said non-access stratum termination point. The at least one memory and the computer program code may further be configured to, with processing circuitry, cause the apparatus at least to, cause the appropriate network function to be provided with one or more security keys corresponding to one or more baseline non-access stratum security keys

In some embodiments, the non-access stratum temporary identifier allows the apparatus to uniquely identify a set of network functions that share context data related with network services provided to the user device's, and to uniquely identify the user device's non-access stratum context. In some embodiments, the non-access stratum termination point comprises an access and mobility management function or session management function. In some embodiments, the non-access stratum temporary identifier identifies an apparatus set in which all apparatus in the apparatus set have access to the same context associated with the non-access stratum termination point. In some embodiments, the non-access stratum temporary identifier identifies a specific apparatus in the apparatus set. In some embodiments, the non-access stratum temporary identifier identifies a group of apparatus sets.

In an example embodiment, a computer program product is provided that includes at least one non-transitory computer-readable storage medium having computer executable program code instructions stored therein with the computer executable program code instructions including program code instructions configured, upon execution, to assign a non-access stratum temporary identifier to a user device, wherein the non-access stratum temporary identifier is associated with a non-access stratum termination point, and wherein a type of non-access stratum termination point is based at least in part on an apparatus type configured to handle one or more non-access stratum messages. The at least one non-transitory computer-readable storage medium having computer executable program code instructions stored therein with the computer executable program code instructions including program code instructions may be further configured, upon execution, to cause the user device to be provided with the non-access stratum temporary identifiers.

The at least one non-transitory computer-readable storage medium having computer executable program code instructions stored therein with the computer executable program code instructions including program code instructions may be further configured, upon execution, to receive, from the user device, a non-access stratum message, wherein the received non-access stratum message corresponds to a non-access stratum message type associated with the apparatus type.

The at least one non-transitory computer-readable storage medium having computer executable program code instructions stored therein with the computer executable program code instructions including program code instructions may be further configured, upon execution, to terminate non-access stratum security that is dedicated to the non-access stratum connection between the user device and the said non-access stratum termination point.

The at least one non-transitory computer-readable storage medium having computer executable program code instructions stored therein with the computer executable program code instructions including program code instructions may be further configured, upon execution, to generate one or more security keys dedicated to the said non-access stratum termination point from one or more baseline non-access stratum security keys.

The at least one non-transitory computer-readable storage medium having computer executable program code instructions stored therein with the computer executable program code instructions including program code instructions may be further configured, upon execution, to receive a non-access stratum message from the user device, wherein the non-access stratum message is associated with a non-access stratum termination point which does not correspond to the apparatus. The at least one non-transitory computer-readable storage medium having computer executable program code instructions stored therein with the computer executable program code instructions including program code instructions may be further configured, upon execution, to select an appropriate network function supporting said non-access stratum termination point based at least in part on the received non-access stratum message.

The at least one non-transitory computer-readable storage medium having computer executable program code instructions stored therein with the computer executable program code instructions including program code instructions may be further configured, upon execution, to cause the appropriate network function to be provided with one or more non-access stratum security keys to be used for a non-access stratum security that is dedicated to the non-access stratum connection between the user device and the said non-access stratum termination point.

The at least one non-transitory computer-readable storage medium having computer executable program code instructions stored therein with the computer executable program code instructions including program code instructions may be further configured, upon execution, to in an instance in which one or more baseline non-access stratum keys have changed, cause the appropriate network function to be provided with the one or more updated security keys to be used for the non-access stratum security that is dedicated to the non-access stratum connection between the user device and the said non-access stratum termination point.

The at least one non-transitory computer-readable storage medium having computer executable program code instructions stored therein with the computer executable program code instructions including program code instructions may be further configured, upon execution, to cause the appropriate network function to be provided with one or more security keys corresponding to one or more baseline non-access stratum security keys.

In some embodiments, the non-access stratum temporary identifier allows the apparatus to uniquely identify a set of network functions that share context data related with network services provided to the user device's, and to uniquely identify the user device's non-access stratum context. In some embodiments, the non-access stratum termination point comprises an access and mobility management function or session management function. In some embodiments, the non-access stratum temporary identifier identifies an apparatus set in which all apparatus in the apparatus set have access to the same context associated with the non-access stratum termination point. In some embodiments, the non-access stratum temporary identifier identifies a specific apparatus in the apparatus set. In some embodiments, the non-access stratum temporary identifier identifies a group of apparatus sets.

In another example embodiment, a method may include receiving a non-access stratum message from a user device, wherein the non-access stratum message is associated with a non-access stratum message container and the user device includes the non-access stratum container type either as part of the non-access stratum temporary identifier or as a separate information element. The method may further include determining an appropriate network function for the non-access stratum message based at least in part on an associated non-access stratum message container. The method may further include causing the non-access stratum message to be provided to the appropriate network function.

The method may further include querying a database or a network repository function to determine the appropriate network function for the non-access-stratum message. In some embodiments, the appropriate network function comprises a subset of a core network function set. In some embodiments, the non-access stratum temporary identifier or the non-access stratum message container includes at least one of an indication of a core network function instance or a core network function set.

In some embodiments, the non-access stratum message container includes a non-access stratum temporary identifier. In some embodiments, the determination of the appropriate network function is based at least in part on the non-access stratum temporary identifier or the type of the non-access stratum container. In some embodiments, the non-access stratum message container includes a data network name and single network slice selection assistance information. In some embodiments, the determination of the appropriate network function is based at least in part on the data network name and the single network slice selection assistance information.

In another example embodiment, an apparatus may include means for receiving a non-access stratum message from a user device, wherein the non-access stratum message is associated with a non-access stratum message container and the user device includes the non-access stratum container type either as part of the non-access stratum temporary identifier or as a separate information element. The apparatus may further include means for determining an appropriate network function for the non-access stratum message based at least in part on an associated non-access stratum message container. The apparatus may further include means for causing the non-access stratum message to be provided to the appropriate network function.

The apparatus may further include means for querying a database or a network repository function to determine the appropriate network function for the non-access-stratum message. In some embodiments, the appropriate network function comprises a subset of a core network function set. In some embodiments, the non-access stratum temporary identifier or the non-access stratum message container includes at least one of an indication of a core network function instance or a core network function set.

In some embodiments, the non-access stratum message container includes a non-access stratum temporary identifier. In some embodiments, the determination of the appropriate network function is based at least in part on the non-access stratum temporary identifier or the type of the non-access stratum container. In some embodiments, the non-access stratum message container includes a data network name and single network slice selection assistance information. In some embodiments, the determination of the appropriate network function is based at least in part on the data network name and the single network slice selection assistance information.

In an example embodiment, an apparatus is provided including at least one processor and at least one memory including computer program code with the at least one memory and the computer program code configured to, with processing circuitry, cause the apparatus at least to receive a non-access stratum message from a user device, wherein the non-access stratum message is associated with a non-access stratum message container and the user device includes the non-access stratum container type either as part of the non-access stratum temporary identifier or as a separate information element. The at least one memory including computer program code with the at least one memory and the computer program code may further be configured to, with processing circuitry, cause the apparatus at least to determine an appropriate network function for the non-access stratum message based at least in part on an associated non-access stratum message container. The at least one memory including computer program code with the at least one memory and the computer program code may further be configured to, with processing circuitry, cause the apparatus at least to cause the non-access stratum message to be provided to the appropriate network function.

The at least one memory including computer program code with the at least one memory and the computer program code may further be configured to, with processing circuitry, cause the apparatus at least to query a database or a network repository function to determine the appropriate network function for the non-access-stratum message. In some embodiments, the appropriate network function comprises a subset of a core network function set. In some embodiments, the non-access stratum temporary identifier or the non-access stratum message container includes at least one of an indication of a core network function instance or a core network function set.

In some embodiments, the non-access stratum message container includes a non-access stratum temporary identifier. In some embodiments, the determination of the appropriate network function is based at least in part on the non-access stratum temporary identifier or the type of the non-access stratum container. In some embodiments, the non-access stratum message container includes a data network name and single network slice selection assistance information. In some embodiments, the determination of the appropriate network function is based at least in part on the data network name and the single network slice selection assistance information.

In an example embodiment, a computer program product is provided that includes at least one non-transitory computer-readable storage medium having computer executable program code instructions stored therein with the computer executable program code instructions including program code instructions configured, upon execution, to receive a non-access stratum message from a user device, wherein the non-access stratum message is associated with a non-access stratum message container and the user device includes the non-access stratum container type either as part of the non-access stratum temporary identifier or as a separate information element.

The at least one non-transitory computer-readable storage medium having computer executable program code instructions stored therein with the computer executable program code instructions including program code instructions may further be configured, upon execution, to determine an appropriate network function for the non-access stratum message based at least in part on an associated non-access stratum message container. The at least one non-transitory computer-readable storage medium having computer executable program code instructions stored therein with the computer executable program code instructions including program code instructions may further be configured, upon execution, to cause the non-access stratum message to be provided to the appropriate network function.

The at least one non-transitory computer-readable storage medium having computer executable program code instructions stored therein with the computer executable program code instructions including program code instructions may further be configured, upon execution, to query a database or a network repository function to determine the appropriate network function for the non-access-stratum message. In some embodiments, the appropriate network function comprises a subset of a core network function set. In some embodiments, the non-access stratum temporary identifier or the non-access stratum message container includes at least one of an indication of a core network function instance or a core network function set.

In an example embodiment, a computer program product is provided that includes at least one non-transitory computer-readable storage medium having computer executable program code instructions stored therein with the computer executable program code instructions including program code instructions configured, upon execution, to receive a non-access stratum message from a user device, wherein the non-access stratum message is associated with a non-access stratum message container and the user device includes the non-access stratum container type either as part of the non-access stratum temporary identifier or as a separate information element.

In an example embodiment, a method is provided which includes receiving one or more non-access stratum temporary identifiers from one or more network entities, wherein each non-access stratum temporary identifier or non-access stratum container type is indicative of a non-access stratum termination point. The method may further include causing the one or more non-access stratum temporary identifiers and non-access stratum container types to be stored.

In some embodiments, the method further includes causing one of the one or more stored non-access stratum temporary identifiers to be provided in a non-access stratum message.

In some embodiments, the method further includes causing one of the one or more stored non-access stratum container types to be provided in a non-access stratum message. The non-access stratum container type may be indicative of the type of outgoing non-access stratum message.

In some embodiments, the method further includes selecting the stored non-access stratum temporary identifier to be provided in a non-access stratum message based at least in part on a type of non-access stratum message.

In some embodiments, the method further includes terminating non-access stratum security that is dedicated to the non-access stratum connection between the user device and the said non-access stratum termination point,

In some embodiments, the provided stored non-access stratum temporary identifier corresponds to an access and mobility management non-access stratum temporary identifier. In some embodiments, the provided stored non-access stratum temporary identifier corresponds to a session management non-access stratum temporary identifier in an instance the non-access stratum message is a session management non-access stratum message. In some embodiments, the provided stored non-access stratum temporary identifier corresponds to an access and mobility management non-access stratum temporary identifier in an instance the non-access stratum message is a protocol data unit session establishment non-access stratum message.

In an example embodiment, an apparatus is provided which includes means for receiving one or more non-access stratum temporary identifiers from one or more network entities, wherein each non-access stratum temporary identifier or the non-access stratum container type is indicative of a non-access stratum termination point. The apparatus may further include means for causing the one or more non-access stratum temporary identifiers and non-access stratum container types to be stored.

In some embodiments, the apparatus further includes means for causing one of the one or more stored non-access stratum temporary identifiers to be provided in a non-access stratum message.

In some embodiments, the apparatus further includes means for selecting the stored non-access stratum temporary identifier to be provided in a non-access stratum message based at least in part on a type of non-access stratum message.

In some embodiments, the apparatus further includes means for causing one of the one or more stored non-access stratum container types to be provided in a non-access stratum message. The non-access stratum container type may be indicative of the type of outgoing non-access stratum message.

In some embodiments, the apparatus further includes means for terminating non-access stratum security that is dedicated to the non-access stratum connection between the user device and the said non-access stratum termination point.

In some embodiments, the provided stored non-access stratum temporary identifier corresponds to an access and mobility management non-access stratum temporary identifier. In some embodiments, the provided stored non-access stratum temporary identifier corresponds to a session management non-access stratum temporary identifier in an instance the non-access stratum message is a session management non-access stratum message. In some embodiments, the provided stored non-access stratum temporary identifier corresponds to an access and mobility management non-access stratum temporary identifier in an instance the non-access stratum message is a protocol data unit session establishment non-access stratum message.

In an example embodiment, an apparatus is provided including at least one processor and at least one memory including computer program code with the at least one memory and the computer program code configured to, with processing circuitry, cause the apparatus at least to receive one or more non-access stratum temporary identifiers from one or more network entities, wherein each non-access stratum temporary identifier or the non-access stratum container type is indicative of a non-access stratum termination point. Processing circuitry and at least one memory including computer program code with the at least one memory and the computer program code may further be configured to, with processing circuitry, cause the apparatus at least to cause the one or more non-access stratum temporary identifiers and non-access stratum container types to be stored.

Processing circuitry and at least one memory including computer program code with the at least one memory and the computer program code may further be configured to, with processing circuitry, cause the apparatus at least to cause one of the one or more stored non-access stratum temporary identifiers to be provided in a non-access stratum message.

Processing circuitry and at least one memory including computer program code with the at least one memory and the computer program code may further be configured to, with processing circuitry, cause the apparatus at least to cause one of the one or more stored non-access stratum container types to be provided in a non-access stratum message. The non-access stratum container type may be indicative of the type of outgoing non-access stratum message.

Processing circuitry and at least one memory including computer program code with the at least one memory and the computer program code may further be configured to, with processing circuitry, cause the apparatus at least to cause one of the one or more stored non-access stratum container types to be provided in a non-access stratum message, wherein the non-access stratum container type is indicative of the type of outgoing non-access stratum message.

Processing circuitry and at least one memory including computer program code with the at least one memory and the computer program code may further be configured to, with processing circuitry, cause the apparatus at least to select the stored non-access stratum temporary identifier to be provided in a non-access stratum message based at least in part on a type of non-access stratum message.

Processing circuitry and at least one memory including computer program code with the at least one memory and the computer program code may further be configured to, with processing circuitry, cause the apparatus at least to terminate non-access stratum security that is dedicated to the non-access stratum connection between the user device and the said non-access stratum termination point.

In some embodiments, the provided stored non-access stratum temporary identifier corresponds to an access and mobility management non-access stratum temporary identifier. In some embodiments, the provided stored non-access stratum temporary identifier corresponds to a session management non-access stratum temporary identifier in an instance the non-access stratum message is a session management non-access stratum message. In some embodiments, the provided stored non-access stratum temporary identifier corresponds to an access and mobility management non-access stratum temporary identifier in an instance the non-access stratum message is a protocol data unit session establishment non-access stratum message.

In an example embodiment, a computer program product is provided that includes at least one non-transitory computer-readable storage medium having computer executable program code instructions stored therein with the computer executable program code instructions including program code instructions configured, upon execution, to cause the apparatus at least to receive one or more non-access stratum temporary identifiers from one or more network entities, wherein each non-access stratum temporary identifier or the non-access stratum container type is indicative of a non-access stratum termination point. The at least one non-transitory computer-readable storage medium having computer executable program code instructions stored therein with the computer executable program code instructions including program code instructions may be further configured, upon execution, to cause the one or more non-access stratum temporary identifiers and non-access stratum container types to be stored.

The at least one non-transitory computer-readable storage medium having computer executable program code instructions stored therein with the computer executable program code instructions including program code instructions may be further configured, upon execution, to cause one of the one or more stored non-access stratum temporary identifiers to be provided in a non-access stratum message.

The at least one non-transitory computer-readable storage medium having computer executable program code instructions stored therein with the computer executable program code instructions including program code instructions may be further configured, upon execution, to cause one of the one or more stored non-access stratum container types to be provided in a non-access stratum message. The non-access stratum container type may be indicative of the type of outgoing non-access stratum message.

The at least one non-transitory computer-readable storage medium having computer executable program code instructions stored therein with the computer executable program code instructions including program code instructions may be further configured, upon execution, to cause one of the one or more stored non-access stratum container types to be provided in a non-access stratum message, wherein the non-access stratum container type is indicative of the type of outgoing non-access stratum message.

The at least one non-transitory computer-readable storage medium having computer executable program code instructions stored therein with the computer executable program code instructions including program code instructions may be further configured, upon execution, to select the stored non-access stratum temporary identifier to be provided in a non-access stratum message based at least in part on a type of non-access stratum message.

The at least one non-transitory computer-readable storage medium having computer executable program code instructions stored therein with the computer executable program code instructions including program code instructions may be further configured, upon execution, to terminate non-access stratum security that is dedicated to the non-access stratum connection between the user device and the said non-access stratum termination point.

In some embodiments, the provided stored non-access stratum temporary identifier corresponds to an access and mobility management non-access stratum temporary identifier. In some embodiments, the provided stored non-access stratum temporary identifier corresponds to a session management non-access stratum temporary identifier in an instance the non-access stratum message is a session management non-access stratum message. In some embodiments, the provided stored non-access stratum temporary identifier corresponds to an access and mobility management non-access stratum temporary identifier in an instance the non-access stratum message is a protocol data unit session establishment non-access stratum message.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts a distributed non-access stratum layer termination within a communication network in an illustrative embodiment;

FIG. 2 shows a communication system in an illustrative embodiment;

FIG. 3 is a block diagram of an apparatus that may be specifically configured in accordance with an example embodiment of the present disclosure;

FIG. 4 shows a message flow for selection of a network function for a non-access stratum security network function selection by a radio access node in an illustrative embodiment;

FIG. 5 shows a message flow for selection of a network function for a non-access stratum security network function selection by an access and mobility management function in an illustrative embodiment;

FIG. 6 illustrates a flow diagram for assigning a non-access stratum temporary identifier to a user device in an illustrative embodiment;

FIG. 7 illustrates a flow diagram for selecting an appropriate network function to support a non-access stratum termination point in an illustrative embodiment;

FIG. 8 illustrates a flow diagram for an alternative method of selecting an appropriate network function to support a non-access stratum termination point in an illustrative embodiment;

FIG. 9 illustrates a flow diagram for receiving one or more non-access stratum temporary identifiers from one or more network entities in an illustrative embodiment; and

FIG. 10 illustrates an example configuration for a session management function set arrangement in an illustrative embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The evolution of new communication technologies such as 5G and 6G have improved upon existing technologies such as a second generation (2G) technologies, third generation (3G) technologies, fourth generation (4G) technologies and long term evolution (LTE) technologies and has thus resulted in improved network connectivity. Conventionally within 5G system (5GS) architectures, a non-access stratum (NAS) termination point is located only at an access and mobility management function (AMF). As such, the AMF serves as a single point of failure such that if the AMF is compromised, the single NAS layer security is also compromised. This may result in the entire registration and connection being compromised and opens the communication network up to potential attacks.

Furthermore, signaling between a radio access node (RAN) and one or more network functions (NFs) within a 5GS are indirect, as such signaling first passes through an AMF prior to reaching the intended NF, such as, for instance a session management function (SMF). This prevents direct interactions between the RAN and NFs in the 5G core network (5GC) such that the full benefits of the service based architecture (SBA) are not used. For example, within an SBA, multiple NFs are organized in sets identified by set identifiers. Within these sets, NFs can handle the same user device (UE) context, thus allowing for NFs to use existing UE context without requiring additional signaling to obtain the UE context. However, while the UE context is available to NFs within the same set, signaling with a particular UE must still first pass through an AMF.

Additionally, the indirect connection between the RAN and NFs contributes to increased signaling latency as a UE initiated service request, such as to reactivate user plane connectivity of a packet data unit (PDU) session, still must be first sent through the AMF, which may be located in a central cloud, even if a SMF and user plane function (UPF) serving the PDU session are located nearby the RAN. The placement location of the AMF and other NFs is also constrained due to the requirement that signaling between the UE and NFs must first pass through the AMF. In turn, this also requires significant processing overheard on the part of the AMF and requires functional coupling with the AMF, which may result in the throttling of signals by the AMF if it experiences overload and/or failures.

Furthermore, underlying NAS containers may be transparently carried to a UE using the underlying NAS layer in an encrypted manner. For example, unified data management (UDM) data may be provided to a user device to avoid tampering of data sent by a home public mobile network (HPLMN) by a visited public land mobile network (VPLMN). Thus, it may be advantageous from a security standpoint to provide data to a user device using a NAS layer.

Therefore, it may be beneficial to include NAS layer termination points that are distributed within a communication network. By including a NAS layer termination point within one or more NFs of a communication network, the collocated NAS layers enable RAN-CORE interface terminations and/or the introduction of direct communication between the RAN or centralized unit control plane (CU-UP) and the NFs in the core network. As such, distributed NAS layer termination points may allow for direct communication between a RAN and the NFs in the core network, thereby reducing signaling latency by eliminating the need to first signal to an AMF, reducing computational resources expended by the AMF, and improving overall network security by enabling containers to be carried to a user device in an encrypted manner using the distributed NAS termination layers.

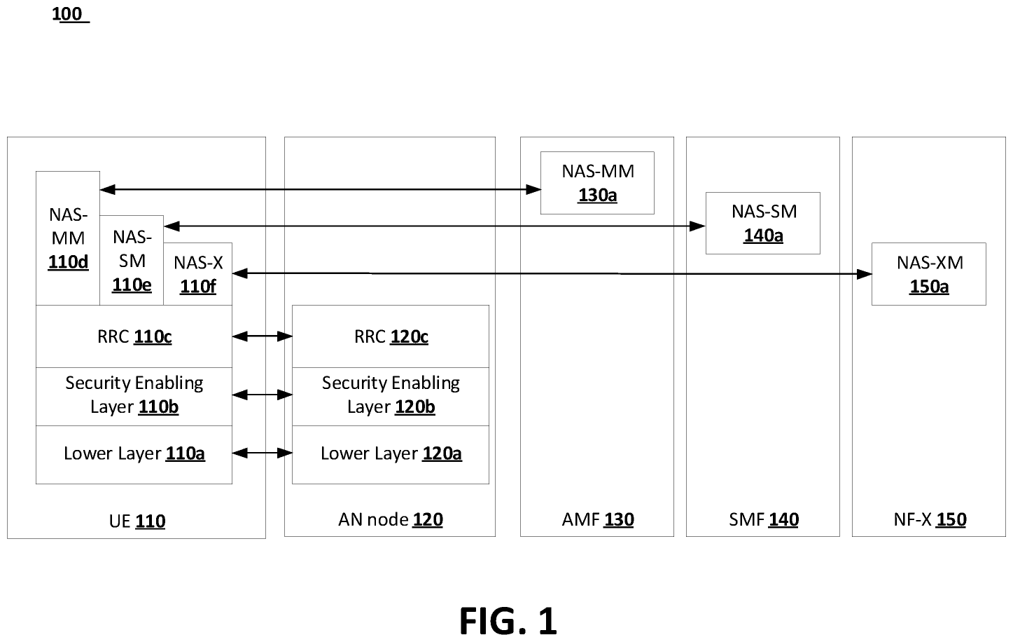

FIG. 1 illustrates an example communication network 100 within which certain illustrative embodiments are to be implemented. However, it is to be appreciated that embodiments are not limited to the network configurations illustrated herein or otherwise described below. It is to be understood that the elements shown in communication system 100 are intended to represent an example embodiment of a distributed NAS layer termination configuration with one or more NFs. Although only an SMF 140 and representative network function (NF-X) 150 are shown, any number of NF-Xs 150 may be contemplated. Furthermore, the NF-X may represent any NF within the communication system, such as, for example an AMF, SMF, policy control function (PCF), etc.

In the communication network 100 depicted in FIG. 1, a distributed NAS layer termination configuration is shown. Within the communication network, a UE 110, an access Network node such as a AN node 120, an AMF 130, an SMF 140, and any NF-X 150 are included (NF-X depicts any other Core Network Function that would terminate NAS signaling exchanges with the UE). The UE 110 and AN (Access Network) e.g. RAN 120 each contain security layers including a lower layer 110a and 120a, security enabling layer 110b and 120b, and AN e.g. radio resource connection (RRC) layer 110c and 120c, which may communicate with one another as shown. Internet Key Exchange as defined in IETF RFC 7296 is another example of an AN protocol that plays the same role as RRC 110c/120c and security Enabling Layers 110b/110c in the figure. Furthermore, in addition to the access and mobility management NAS (NAS-MM) termination point 130a in AMF 130, session management NAS (NAS-SM) termination point 140a in SMF 140, and representative NAS (NAS-XM) termination point 150a in NF-X 150 are included within the communication network 100. Each termination point may be associated with a unique NAS temporary identifier (NAS TMSI). Each NAS TMSI is provided to the UE along with a NAS message such that the UE may provide these NAS TMSIs to an AN e.g. RAN node and/or AMF 130 to enable the selection of different NAS termination points based at least in part on the provided NAS TMSI. A NAS security dedicated to the NAS connection between the UE 110 and the NF-X 150 may be activated between the NF-X 150 described by the NAS TMSI and the UE.

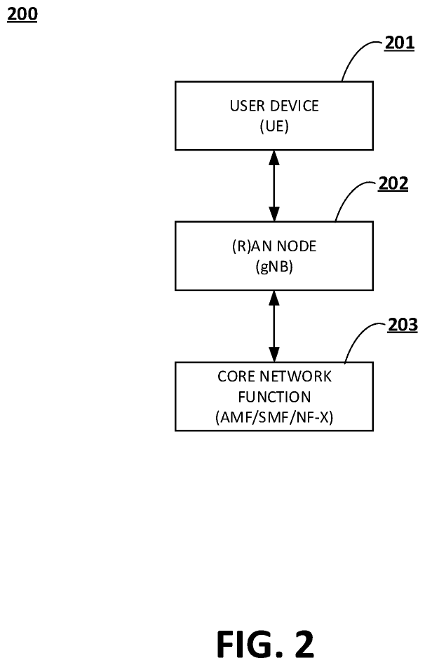

FIG. 2 shows a communication system 200 within which certain illustrative embodiments are to be implemented. However, it is to be appreciated that embodiments are not limited to the network configurations illustrated herein or otherwise described below. It is to be understood that the elements shown in communication system 200 are intended to represent a primary function provided within the system. As such, the blocks shown in FIG. 2 reference specific elements in 5G networks that provide the primary functions. However, other network elements may be used to implement some or all of the primary functions represented. Also, it is to be understood that not all functions of a 5G network are depicted in FIG. 2. Rather, functions that facilitate an explanation of illustrative embodiments are represented.

By way of example, the communication system 200 may be deployed within a radio access architecture. However, the system may be deployed in other applications including within other communication networks including, for example, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any access network eligible to access the 5G core network such as an Un-trusted Non 3GPP access terminated at a Non-3GPP interworking function (N3IWF), a trusted Non-3GPP access terminated at a trusted non-3GPP gateway function (TNGF) or a Wireline access terminated at a wireless access gateway function (W-AGF) may be used instead of the NG RAN/gNB. Moreover, although described herein in conjunction with a 5G core network, the method, apparatus and computer program product of certain example embodiments may be employed in conjunction with other technologies, such as a 6G network or the like.

In the radio access architecture of FIG. 2, user device 201 is configured to be in a wireless connection on one or more communication channels in a cell with a radio access network (RAN) node, such as a gNB. The physical link from a user device 201 to a gNB is called the uplink or reverse link and the physical link from the gNB to the UE is called the downlink or forward link. It should be appreciated that the gNBs, or their functionalities may be implemented by using any node, host, server or access point (AP), etc. entity suitable for such a usage.

A communications system typically comprises more than one gNB, in which case the gNBs may also be configured to communicate with one another over links, wired or wireless, designed for the purpose. These links may be used for signaling purposes. The gNB is a computing device configured to control the radio resources of the communication system to which the gNB is coupled. The gNB may also be referred to as a base station, an access point or any other type of interfacing device including a relay station capable of operating in a wireless environment. The gNB includes or is coupled to transceiver(s). From the transceivers of the gNB, a connection is provided to an antenna unit that establishes bi-directional radio links to UEs. As such, the transceivers of the gNB and the transceivers of the UEs may include transmitters and receivers configured to communicate via a channel. Although reference is made to a gNB herein, although this is by way of example, but not of limitation, as other types of AN nodes may alternatively be employed.

Accordingly, as shown, communication system 200 comprises UE 201 that communicates, such as via an air interface, with a AN node 202. In some embodiments, the AN node 202 is a RAN node. The UE 201 may be a mobile station, and such a mobile station may comprise, by way of example, a mobile telephone, a computer, or any other type of communication device. In an LTE-V2X implementation, one or more UEs may be deployed in a given vehicle. The term “user device” or “user equipment” as used herein is therefore intended to be construed broadly, so as to encompass a variety of different types of mobile stations, subscriber stations or, more generally, communication devices, including examples such as a combination of a data card inserted in a laptop or other equipment (e.g., a vehicle). The user device 201 may also refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a UE may also be a nearly exclusive uplink only device, of which an example is a camera or video camera loading images or video clips to a network. A UE may also be a device having the capability to operate in an IoT network, which is a scenario in which objects are provided with the ability to transfer data over a network without requiring human-to-human or human-to-computer interaction. The user device (or in some embodiments a layer 3 relay node) is configured to perform one or more user device functionalities. The user device may also be called a subscriber unit, mobile station, remote terminal, access terminal, user terminal or user equipment just to mention but a few names or apparatuses.

In one embodiment, UE 201 is comprised of a Universal Integrated Circuit Card (UICC) and Mobile Equipment (ME). The UICC is the user-dependent part of the UE and contains at least one Universal Subscriber Identity Module (USIM) and appropriate application software. The USIM securely stores the International Mobile Subscriber Identity (IMSI) number and its related key, which are used to identify and authenticate subscribers to access networks. The ME is the user-independent part of the UE and contains terminal equipment (TE) functions and various mobile termination (MT) functions.

The AN node 202 is illustratively part of a RAN of the communication system 200. In a 5GS network, the AN node is typically implemented by an gNB. Such an access network may comprise, for example, a plurality of base stations which may include one or more gNBs (which may also be split in a centralized unit (CU) and a distributed unit (DU) part) and/or other AN node types, such as evolved node Bs (eNBs), node Bs, base stations (BTS) and/or non-3GPP interworking function (N3IWF), or any other types of access nodes such as WLAN access points, as well as one or more associated radio network control functions. The base stations and radio network control functions may be logically separate entities, but in a given embodiment may be implemented in the same physical network element, such as, for example, a base station router or femto cellular access point. As will be appreciated by one of skill in the art, any variety of AN nodes and/or access nodes may also implement similar operations, functions, etc.

In some example embodiments, the AN node 202 is operatively coupled to a core network function 203, such as via an NG interface. The network function 203 may include an AMF, SMF, or any of core network function. A core network function may be an element of the core network (CN) part of the communication network 200 that is responsible for one or more associated operations. The core network function may serve as a NAS termination point for a NAS layer security. Each NAS termination point may be uniquely identified using a NAS temporary identifier.

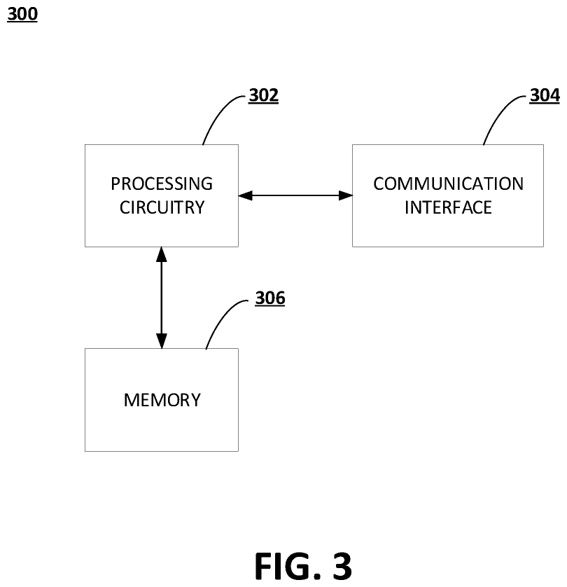

One example of an apparatus 300 that may be configured to function as or may be embodied by a network entity, such as a UE, AN node, AMF, SMF and/or NF-X, is depicted in FIG. 3. As shown in FIG. 3, the apparatus 300 includes, is associated with or is in communication with processing circuitry 302, a memory 306 and a communication interface 304. The processing circuitry 302 may be in communication with the memory device via a bus for passing information among components of the apparatus 300. The memory device 306 may be non-transitory and may include, for example, one or more volatile and/or non-volatile memories. In other words, for example, the memory device 306 may be an electronic storage device (e.g., a computer readable storage medium) comprising gates configured to store data (e.g., bits) that may be retrievable by a machine (e.g., a computing device like the processing circuitry). The memory device 306 may be configured to store information, data, content, applications, instructions, or the like for enabling the apparatus to carry out various functions in accordance with an example embodiment of the present disclosure. For example, the memory device 306 could be configured to buffer input data for processing by the processing circuitry 302. Additionally or alternatively, the memory device 306 could be configured to store instructions for execution by the processing circuitry 302.

The apparatus 300 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 302 may be embodied in a number of different ways. For example, the processing circuitry 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 302 may be configured to execute instructions stored in the memory device 306 or otherwise accessible to the processing circuitry 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry 302 is embodied as an executor of instructions, the instructions may specifically configure the processor to perform the algorithms and/or operations described herein when the instructions are executed. However, in some cases, the processing circuitry 302 may be a processor of a specific device (e.g., an image or video processing system) configured to employ an embodiment of the present invention by further configuration of the processing circuitry by instructions for performing the algorithms and/or operations described herein. The processing circuitry 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

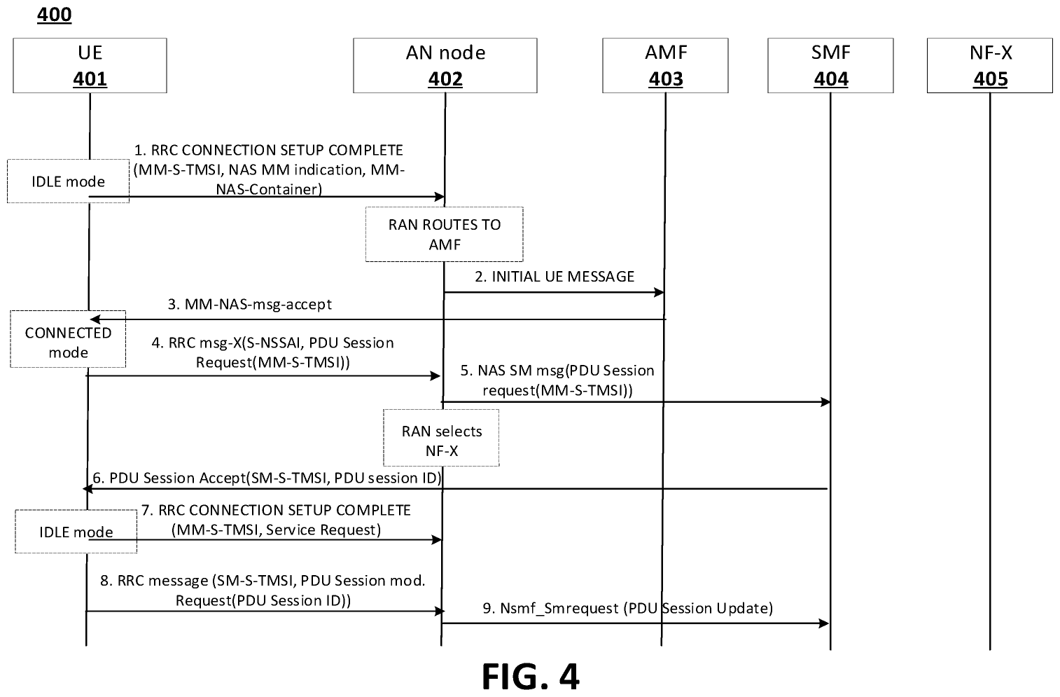

FIG. 4 illustrates messages exchanged between a UE 401 and a AN node 402 during registration to establish a session and obtain internet protocol (IP) connectivity in accordance with an example embodiment. As illustrated in FIG. 4, a AN node 402 may select a NF-X 405 for the associated UE. As will be discussed herein, an example embodiment where a AN node 402 selects an SMF 404 will be discussed. However, it should be appreciated that any NF-X 405, such as PCF, AMF, etc. may also be contemplated.

In operation 1 of FIG. 4, the UE 401 may begin in idle mode and may provide an RRC connection setup complete message (i.e., an RRC msg5) to a AN node 402 once the RRC connection has been completed. In some embodiments, the RRC connection setup complete message may include a registration and mobility management system architecture evolution session temporary identifier (MM-S-TSMI), NAS registration and mobility management indication (NAS MM indication), and/or NAS registration and mobility management NAS Container (MM-NAS-Container). The MM-NAS-Container may include an access and mobility management NAS (MM-NAS) message to be delivered and the NAS MM indication may indicate the type of NAS message (e.g. MM-NAS). In some embodiments, the MM-S-TMSI may include a set identifier, a pointer to an AMF instance, and/or a mobile temporary identifier (M-TMSI) that uniquely identifies the requesting UE 401.

In operation 2 of FIG. 4, the AN node 402 selects an AMF 403. In some embodiments, the AN node 402 may select the AMF 403 based at least in part on the NAS MM indication. The AN node 402 may additionally or alternatively select AMF 403 based at least in part on the provided set identifier and/or the AMF pointer included in the MM-S-TMSI. Once selected, the AN node 402 may then forward the MM-NAS-Container with the MM-NAS message to the selected AMF 403 in an initial UE message.

In operation 3 of FIG. 4, the AMF 403 may process the MM-NAS message included in the MM-NAS-Container and provide a MM-NAS-msg-accept message to UE 401 indicative of successful connection establishment. In some embodiments, the AMF 403 may perform various subscription verification procedures and/or authentication procedures while processing the MM-NAS message. The UE 401 may enter a connected mode upon receipt of the MM-NAS-msg-accept message.

In operation 4 of FIG. 4, the UE 401 may determine a need to send a NAS session management (NAS-SM) message to a SMF 404. Alternatively, the UE 401 may determine a need to send a NAS representative (NAS-XM) message to a NF-X 405. The UE 401 may then send an RRC message to AN node 402. The RRC message may include the corresponding NAS message container along with criteria for NF-SM and/or NAS-XM selection. In some embodiments, the criteria for NF-SM and/or NAS-XM selection is a single network slice assistance information (S-NSSAI) value to identify a network slice in the communication network. In some embodiments, the RRC message may further include a PDU session request message that further includes the MM-S-TMSI.

In operation 5 of FIG. 4, the AN node 402 may discover and select the appropriate SMF 404 and provide the PDU session request with the MM-S-TMSI to the selected SMF 404. Alternatively, the AN node 402 may discover and select the appropriate NF-X 405 and provide the MM-S-TMSI to the selected NF-X 405. The PDU session request may include the NAS XM message. The SMF 404 and/or NF-X 405 may then validate the UE status with the AMF 403. In some embodiments, this validation is based at least in part on the provided MM-S-TMSI. In this way, the SMF 404 and/or NF-X 405 may ensure it is authorized to perform registration at the representative layer, which is a pre-requisite for PDU session establishment. In some embodiments, SMF 404 and/or NF-X 405 may additionally request AMF 403 to enforce NAS security termination of the NAS SM message and/or NAS XM message. Alternatively, the SMF 404 and/or NF-X 405 may activate security for the representative layer once it receives authorization from the AMF 403 for the given UE 401.

In operation 6 of FIG. 4, the SMF 404 provides a PDU session accept message to UE 401 in response to the PDU session request message. In the PDU session accept message, the SMF 404 may allocate a session management system architecture evolution session temporary identifier (SM-S-TMSI) for the UE 401 and particular PDU session. This may begin the NAS SM security for the PDU session. Alternatively, the NF-X 405 may provide a message to the UE 401 which includes the provision of a representative system architecture evolution session temporary identifier (XM-S-TMSI) for the UE 401 and particular PDU session. This may begin the NAS XM security for the connection session.

In operation 7 of FIG. 4, the UE 401 may restart from idle mode and may request to modify the PDU session and/or connection session. The UE 401 may provide a RRC connection setup complete message to AN node 402 upon completion of the RRC connection setup. The RRC connection setup complete message may now include a NAS Service request and/or MM-S-TMSI. In contrast to operation 1 of FIG. 4, which also begins with UE 401 in idle mode, UE 401 no longer needs to provide a NAS MM indication or MM-NAS container with the RRC connection setup complete message.

In operation 8 of FIG. 4, the UE 401 may provide an RRC message to the AN node 402. The RRC message may include the SM-S-TMSI and PDU modification request. The UE 401 may now provide the NAS SM container along with the SM-S-TMSI in the PDU modification request. This enables the AN node 402 to route the NAS message directly to the SMF 404 without first signaling to the AMF 403. Alternatively, the RRC message may include the XM-S-TMSI and a session identifier to enable the AN node 402 to route the NAS message directly to the NF-X 405.

In operation 9 of FIG. 4, the AN node 402 may provide a network slice management function (NSMF) representative request to the NF-X 405. The AN node 402 may determine the appropriate SMF 404 based at least in part on the provided SM-S-TMSI. Alternatively, the AN node 402 may determine the appropriate NF-X 405 based at least in part on the provided XM-S-TMSI.

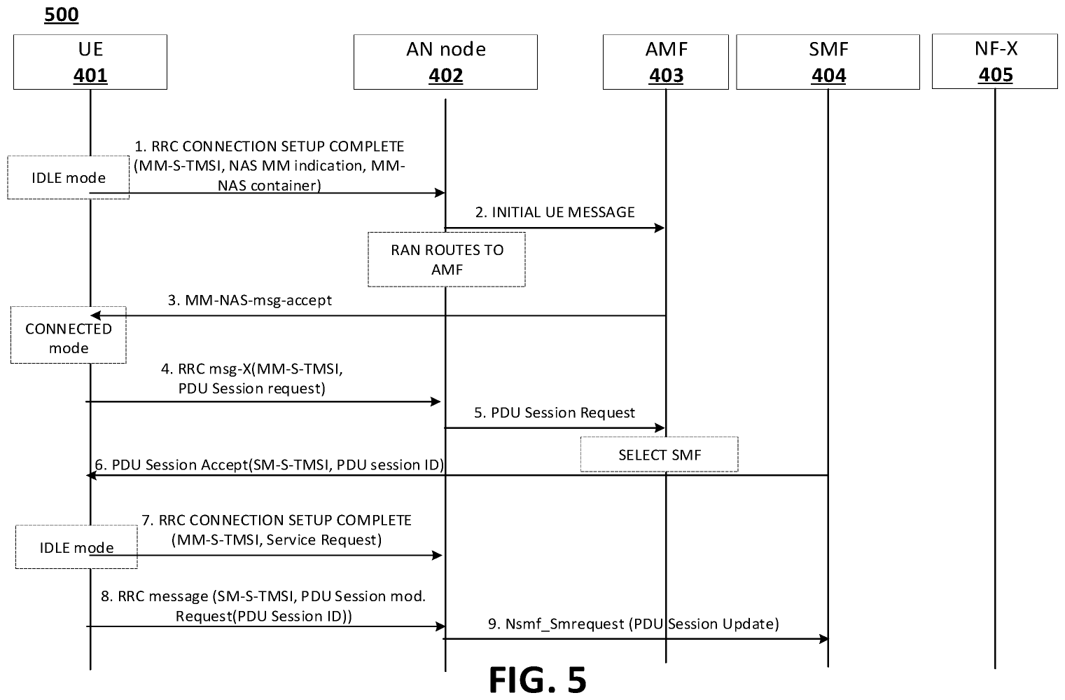

FIG. 5 illustrates messages exchanged between a UE 401 and a AN node 402 during registration to establish a session and obtain internet protocol (IP) connectivity in accordance with an example embodiment. As illustrated in FIG. 5, an AMF 403 may select a NF-X 405 for the associated UE. As will be discussed herein, an example embodiment where an AMF 403 selects an SMF 404 will be discussed. However, it should be appreciated that any NF-X 405, such as PCF, AMF, etc. may also be contemplated to be selected.

Operations 1-4 of FIG. 5 may be performed substantially similarly to operations 1-4 as described in FIG. 4.

In operation 5 of FIG. 5 the AN node 402 may forward the PDU session request to AMF 403. The PDU session request may include the NAS-SM container. The AMF 403 may perform discovery and selection operations to select the appropriate SMF 404. In some embodiments, AMF 403 may select the SMF 404 based at least in part on a domain name network and/or S-NSSAI provided in the PDU session request. Alternatively, the AMF 403 may select a NF-X 405 based at least in part on a domain name network and/or S-NSSAI.

In operation 6 of FIG. 5, the selected SMF 404 may provide a PDU session accept message to UE 401. In the PDU session accept message, the SMF 404 may allocate a SM-S-TMSI for the UE 401 and particular PDU session. This may begin the NAS SM security for the PDU session. Alternatively, the NF-X 405 may allocate a XM-S-TMSI for the UE 401 and particular connection session and thereby begin the NAS XM security for the connection session.

Operations 7-9 of FIG. 5 may be performed substantially similarly to operations 7-9 as described in FIG. 4.

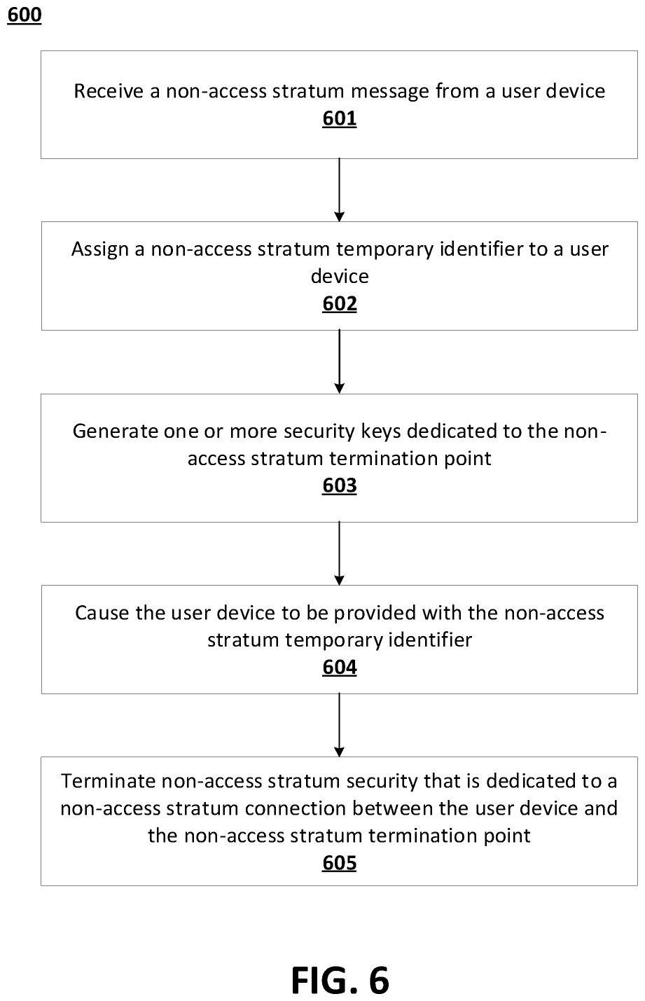

Referring now to FIG. 6, an example flowchart 600 implemented, for example, by an apparatus 300 embodied by a network entity, such as SMF 404, configured to assign a corresponding NAS TMSI to a UE will be discussed herein. In some embodiments, the NF-X 405 may be AMF 403, a SMF 404, a PCF, etc.

As shown in block 601, the apparatus 300 embodied by a network entity, such as NF-X 405, may include means, such as the processing circuitry 302, the communication interface 304 or the like, for receiving a NAS message from a UE, such as UE 401. In some embodiments, the received NAS message may be an RRC connection setup complete message. In some embodiments, the received NAS message may be a PDU session request or a PDU session update. In some embodiments, the received NAS message corresponds to a particular NAS message type associated with the apparatus 300 type. For example, a NF-X 405 embodied as an SMF may receive a session management NAS (SM-NAS) message.

At block 602, the apparatus 300 embodied by a network entity, such as NF-X 405, may include means, such as the processing circuitry 302, the memory 306 or the like, for assigning a NAS termination point, such as an identifier of a NAD termination point, e.g., NAS TMSI, to the UE 401. The NAS TMSI may be associated with a particular NAS termination point associated with the NF-X 405. Furthermore, the type of NAS termination point may be based at least in part on the apparatus 300 type which is configured to handle one or more NAS messages. For example, a NF-X which is embodied as an SMF may assign a session management TMSI (SM-TMSI).

In some embodiments, the identifier, e.g., NAS TMSI, is assigned based at least in part on a globally unique temporary identifier (GUTI). The NAS TMSI may uniquely identify a set of NF-Xs which share context data and uniquely identify a UE's NAS context. For example, an SMF may be associated with a SMF set and/or SMF group. In some embodiments, the identifier, e.g., NAS TMSI, may also identify a NF-X set and/or NF-X group to which the apparatus 300 belongs. In some embodiments, the identifier, e.g., NAS TMSI, may identify a specific NF-X within the NF-X set and/or NF-X group.

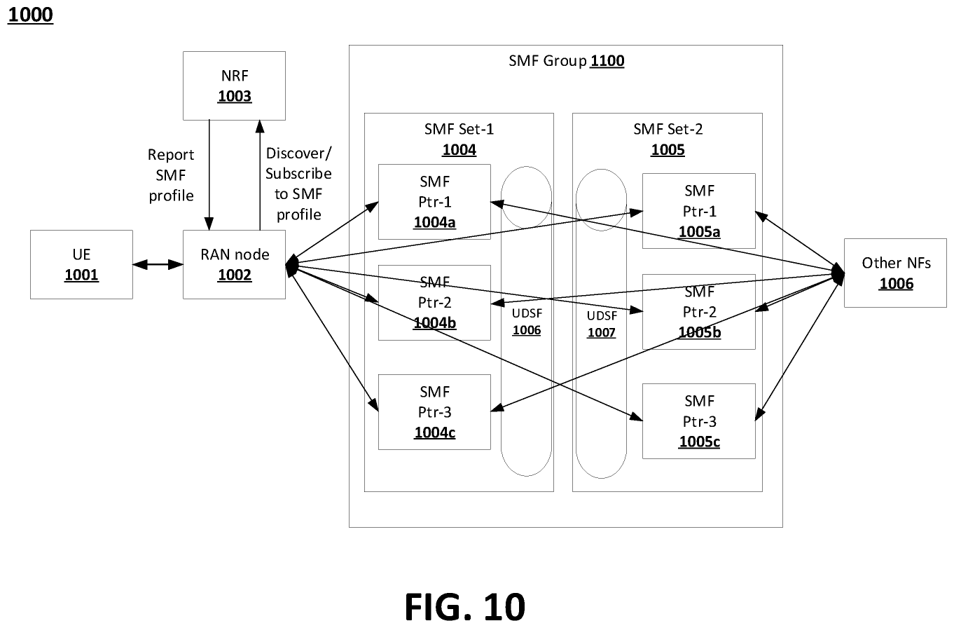

Referring now to FIG. 10 and by way of example of an NF-X, example SMF set configurations and an SMF group configuration are depicted. A particular SMF, such as SMF 1004a may belong to a particular SMF set 1004. The SMF set 1004 may include one or more additional SMFs, such as SMF 1004b-c. The SMFs included in a particular SMF set may serve a given geographical area and a particular network slice. All SMFs within a particular SMF set may access the same UE context. In some embodiments, the SMFs may access such UE context from an unstructured data storage function (UDSF), such as USDF 1006.

Additionally, an SMF group, such as SMF group 1100 may include two or more SMF sets, such as SMF set 1004 and SMF set 1005. An SMF set within an SMF group may also access the same UE context from other SMF sets within the same SMF group. However, each SMF set may still be associated with a particular USDF.

In some embodiments, a AN node, such as AN node 402 may discover SMF profiles from a network repository function (NRF). The AN node 402 may discover such SMF profiles using a network function discovery request and/or by subscribing to NRF notifications regarding SMF profiles.

Although FIG. 10 is described in the context of SMF set configuration and SMF group configuration, other network functions, such as the PCF, may also be arranged in similar configurational sets and/or groups.

Referring now to FIG. 6, at block 603, the apparatus 300 embodied by a network entity, such as NF-X 405, may include means, such as the processing circuitry 302, memory 306, or the like, for generating one or more security keys dedicated to the NAS termination point embodied by the particular apparatus 300. In some embodiments, the one or more generated security keys may be generated from one or more baseline NAS security keys. In some embodiments, once generated, the NAS security keys are stored in an associated memory, such as memory 306.

In some embodiments, the one or more baseline NAS security keys may be generated by the NF-X, such as AMF 403. In some embodiments, the AMF 403 may provide NF-X 405 with the one or more baseline NAS security keys. For example, if the NF-X 405 is an SMF, the AMF 403 may provide the one or more baseline NAS security keys during a PDU session establishment request. As another example, if the NF-X 405 is a PCF, the AMF 403 may provide the one or more baseline NAS security keys during an association with the PCF designated to respond to delivering UE policies. In some embodiments, the NF-X 405 may deduce the one or more generated NAS security keys using the received baseline NAS security keys.

At block 604, the apparatus 300 embodied by a network entity, such as AMF 403, SMF 404, or NF-X 405, may include means, such as the processing circuitry 302, communication interface 304, or the like, for causing the UE, such as UE 401 to be provided with the one or more identifiers, such as one or more NAS TMSIs. In some embodiments, the UE 401 may be provided the one or more identifiers, e.g., NAS TMSIs, in a PDU session accept message when the NF-X 405 is an SMF.

At block 605, the apparatus 300 embodied by a network entity, such as NF-X 405, may include means, such as the processing circuitry 302, communication interface 304, or the like, for terminating a NAS security dedicated to the NAS connection between the UE 401 and the NAS termination point in the NF-X 405. Once the NAS security is terminated, the NAS connection between the UE 401 and NF-X 405 may be severed. Advantageously, if the UE 401 has one or more other NAS connections with one or more other NAS termination points of other NF-Xs, these NAS connections may be maintained. Additionally, terminating the NAS security allows for encryption and integrity protection amongst the communication network as a whole.

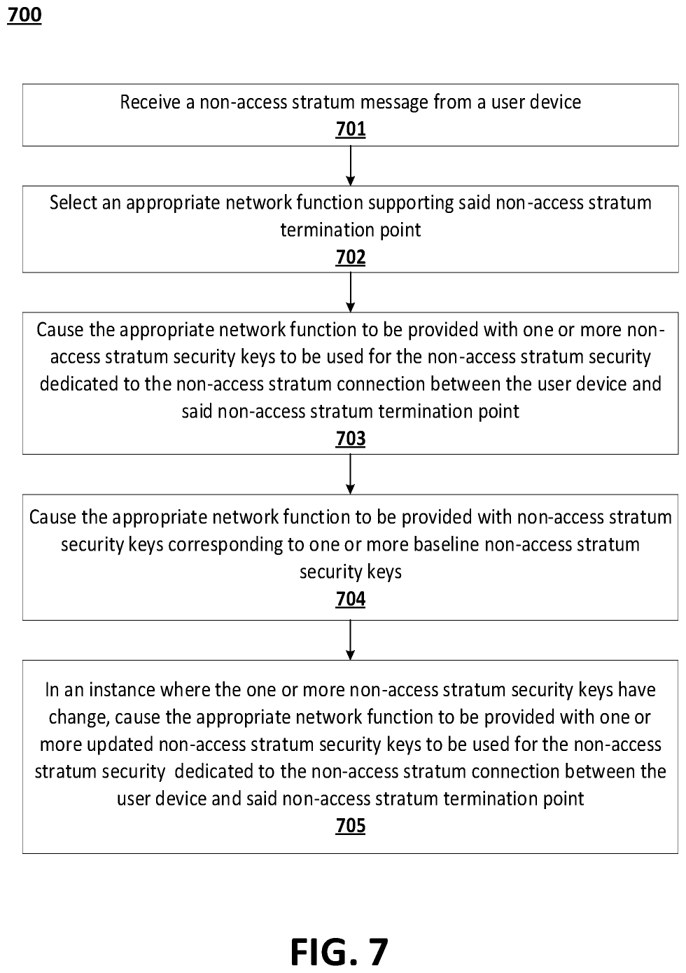

Referring now to FIG. 7, an example flowchart 700 implemented, for example, by an apparatus 300 embodied by a network entity, such as AMF 403, configured to cause the selection of an appropriate network function to support a NAS termination point will be discussed herein.

As shown in block 701, the apparatus 300 embodied by a network entity, such as AMF 403, may include means, such as the processing circuitry 302, communication interface 304, or the like, for receiving a NAS message from a UE, such as UE 401. In some embodiments, the NAS message may be included in an RRC connection setup complete message. In some embodiments, the NAS message may be included within a MM-NAS-Container.

As shown in block 702, the apparatus 300 embodied by a network entity, such as AMF 403, may include means, such as the processing circuitry 302, memory 306, or the like, for selecting an appropriate NF to support a NAS termination point. In some embodiments, the appropriate NF may be selected based at least in part on the type of NAS messaged received. For example, if the NAS message may include a SM-S-TMSI and as such, may indicate to the AMF 403 to select a SMF as the appropriate NF.

As shown in block 703, the apparatus 300 embodied by a network entity, such as AMF 403, may include means, such as the processing circuitry 302, communication interface 304, memory 306, or the like, for causing the appropriate NF to be provided with one or more NAS security keys to be used for the NAS security dedicated to the NAS connection between the UE 401 and the NAS termination point hosted by the NF-X 405. In some embodiments, the one or more NAS security keys may be one or more baseline NAS security keys.

In some embodiments, as shown in block 704, the apparatus 300 embodied by a network entity, such as AMF 403, may include means, such as the processing circuitry 302, communication interface 304, or the like, for, causing the appropriate NF to also be provided with NAS security keys. In some embodiments, the NAS security keys correspond to one or more baseline NAS security keys.

In some embodiments, as shown in block 705, the apparatus 300 embodied by a network entity, such as AMF 403, may include means, such as the processing circuitry 302, communication interface 304, or the like, for, in an instance where one or more NAS security keys have changed, causing the appropriate NF to be provided with one or more updated NAS security keys. The one or more updated NAS security keys may be used for the NAS security dedicated to the NAS connection between the UE 401 and the NAS termination point hosted by the NF-X 405.

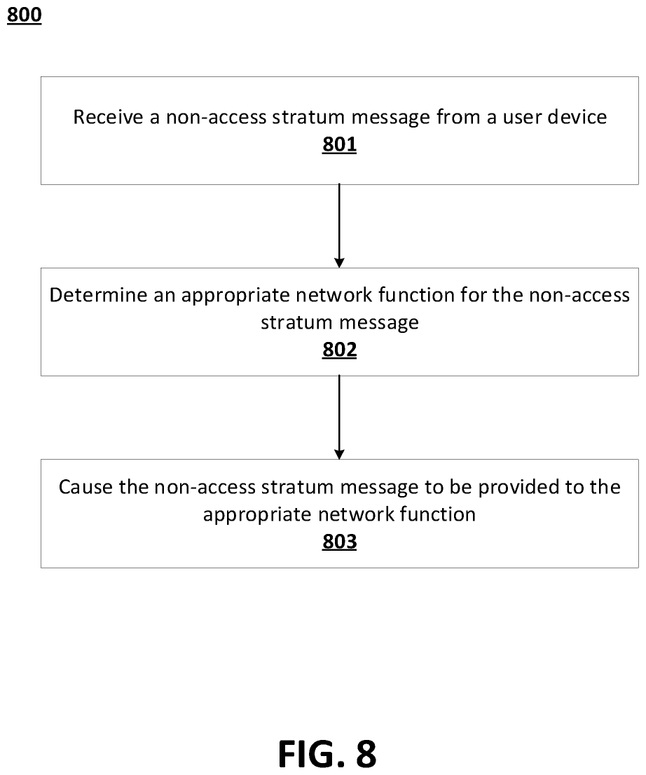

Referring now to FIG. 8, an example flowchart 800 implemented, for example, by an apparatus 300 embodied by a AN node, such as RAN 402, configured to determine the selection of an appropriate NF to support a NAS termination point will be discussed herein.

As shown in block 801, the apparatus 300 embodied by a AN node, such as AN node 402, may include means, such as the processing circuitry 302, communication interface 304, or the like, for receiving one or more NAS messages from a UE, such as UE 401. In some embodiments, the NAS message may be included in an RRC connection setup complete message. In some embodiments, the NAS message may be included within a MM-NAS-Container. In some embodiments, the MM-NAS-Container includes a data network name (DNN) and/or S-NSSAI.

As shown in block 802, the apparatus 300 embodied by a AN node, such as AN node 402, may include means, such as the processing circuitry 302 or the like, for determining an appropriate NF for the NAS message. In some embodiments, the determination of the appropriate NF is determined based at least in part on the NAS TMSI and/or the NAS container. In some embodiments, the determination of the appropriate NF is determined based at least in part on the DNN and/or S-NSSAI included in the MM-NAS-Container. In some embodiments, the appropriate NF may be selected based at least in part on the type of NAS messaged received. For example, if the NAS message may include a SM-S-TMSI and as such, may indicate to the AN node 402 to select a SMF as the appropriate NF. Additionally or alternatively, the determination of the appropriate NF is determined by querying a database and/or network repository function.

As shown in block 803, the apparatus 300 embodied by a AN node, such as AN node 402, may include means, such as the processing circuitry 302, communication interface 304 or the like, for causing the NAS message to be provided to the appropriate NF.

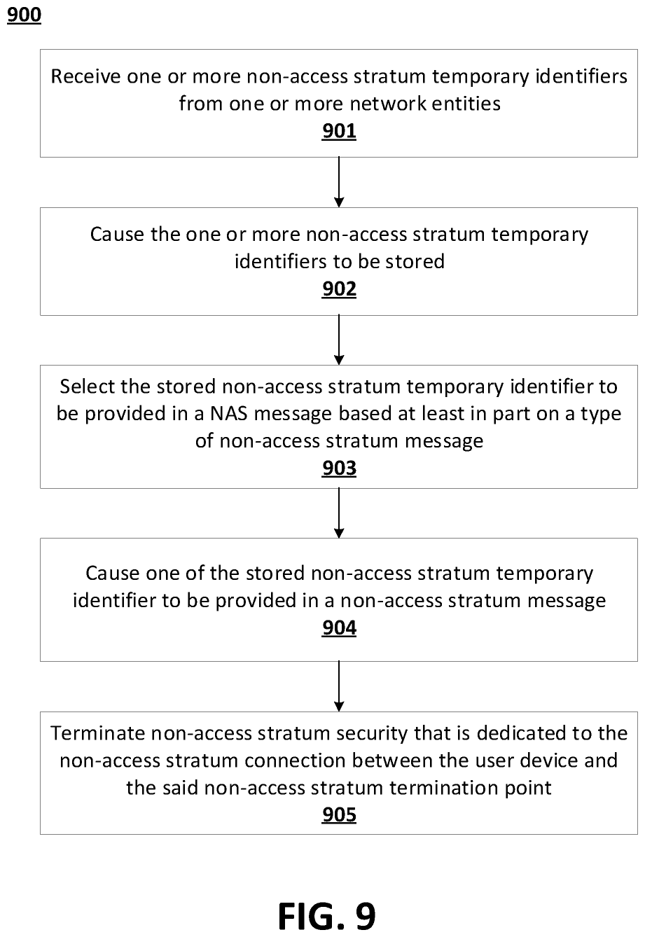

Referring now to FIG. 9, an example flowchart 900 implemented, for example, by an apparatus 300 embodied by a UE, such as UE 401 configured to receive and store one or more NAS TMSIs from one or more network entities will be discussed herein.

As shown in block 901, the apparatus 300 embodied by a UE, such as UE 401, may include means, such as the processing circuitry 302, communication interface 304, or the like, for receiving one or more NAS TMSIs from one or more network entities.

As shown in block 902, the apparatus 300 embodied by a UE, such as UE 401, may include means, such as the processing circuitry 302, memory 306, or the like, for causing the one or more identifiers, such as NAS identifiers and, more particularly, NAS TMSIs, to be stored. For example, the UE 401 may store the one or more identifiers, e.g., NAS TMSIs, in an associated memory, such as memory 306. As such, the UE 401 may access an appropriate identifier, e.g., NAS TMSI, when sending a NAS message to a particular NF-X.

As shown in block 903, the apparatus 300 embodied by a UE, such as UE 401, may include means, such as the processing circuitry 302, memory 306, or the like, for selecting the stored identifier, e.g., NAS TMSI, to be provided in a NAS message based at least in part on a type of NAS message. For example, if UE 401 determines a need to send a NAS message to a SMF, the UE 401 may select the stored NAS TMSI corresponding to the SMF, e.g., SM-TMSI.

As shown in block 904, the apparatus 300 embodied by a UE, such as UE 401, may include means, such as the processing circuitry 302, communication interface 304, or the like, for causing the stored identifier, e.g., NAS TMSI, to be provided in a NAS message. In some embodiments, the UE may provide the identifier, e.g., NAS TMSI, in an RRC message. The NAS TMSI may be provided in a NAS container corresponding to the type of NAS message. For example, a SM-S-TMSI may be provided in a SM container type message. As such, in some embodiments, the container type may be indicative of the type of outgoing NAS message.

As shown in block 905, the apparatus 300 embodied by a UE, such as UE 401, may include means, such as the processing circuitry 302, communication interface 304, or the like, for terminating NAS security dedicated to a NAS connection between said UE 401 and a NAS termination point within a NF-X, such as NF-X 405. Once the NAS security is terminated, the NAS connection between the UE 401 and NF-X 405 may be severed. Advantageously, if the UE 401 has one or more other NAS connections with one or more other NAS termination points of other NF-Xs, these NAS connections may be maintained. Additionally, terminating the NAS security allows for encryption and integrity protection amongst the communication network as a whole.

As such, it may be beneficial to include NAS layer termination points that are distributed within a communication network. The inclusion of NAS layer termination points within one or more NFs, such as SMF 404, AMF 403, PCF, and/or the like of a communication network allows for collocated NAS layers which enable RAN-CORE interface terminations and/or the introduction of direct communication between the RAN, CU-UP and/or the NFs in the core network. As such, distributed NAS layer termination points allow for direct communication between a RAN and the NFs in the core network, thereby reducing signaling latency by eliminating the need to first signal to an AMF 403, reducing computational resources expended by the AMF 403, and improving overall network security by enabling containers to be carried to a user device 401 in an encrypted manner using the distributed NAS termination layers.

FIGS. 6-9 illustrate message flows and flow charts depicting methods according to an example embodiment of the present invention. It will be understood that each block of the message flow may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 306 of an apparatus 300 employing an embodiment of the present invention and executed by a processing circuitry 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts and message flows support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although a few variations have been described in detail above, other modifications or additions are possible. In particular, further features and/or variations may be provided in addition to those set forth herein. Moreover, the implementations described above may be directed to various combinations and sub-combinations of the disclosed features and/or combinations and sub-combinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

It should therefore again be emphasized that the various embodiments described herein are presented by way of illustrative example only and should not be construed as limiting the scope of the claims. For example, alternative embodiments can utilize different communication system configurations, user equipment configurations, base station configurations, identity request processes, messaging protocols and message formats than those described above in the context of the illustrative embodiments. These and numerous other alternative embodiments within the scope of the appended claims will be readily apparent to those skilled in the art.

1. An apparatus comprising:
processing circuitry including at least one processor; and
at least one memory including computer program code,
the at least one memory and the computer program code configured to, with the processing circuitry, cause the apparatus at least to:
assign a non-access stratum temporary identifier to a user device, wherein the non-access stratum temporary identifier is associated with a non-access stratum termination point, and wherein a type of non-access stratum termination point is based at least in part on an apparatus type configured to handle one or more non-access stratum messages; and
cause the user device to be provided with the non-access stratum temporary identifiers.

2. The apparatus of claim 1, wherein the at least one memory and the computer program code are configured to, with the processing circuitry, further cause the apparatus at least to:
receive, from the user device, a non-access stratum message, wherein the received non-access stratum message corresponds to a non-access stratum message type associated with the apparatus type.

3. The apparatus of claim 1, wherein the non-access stratum temporary identifier allows the apparatus to uniquely identify a set of network functions that share context data related with network services provided to the user device's, and to uniquely identify the user device's non-access stratum context.

4. The apparatus of claim 1, wherein the at least one memory and the computer program code are configured to, with the processing circuitry, further cause the apparatus at least to:
terminate non-access stratum security that is dedicated to the non-access stratum connection between the user device and the said non-access stratum termination point.

5. The apparatus of claim 4, wherein the at least one memory and the computer program code are configured to, with the processing circuitry, further cause the apparatus at least to perform:
generate one or more security keys dedicated to the said non-access stratum termination point from one or more baseline non-access stratum security keys.

6. The apparatus of claim 1, wherein the at least one memory and the computer program code are configured to, with the processing circuitry, further cause the apparatus at least to:
receive a non-access stratum message from the user device, wherein the non-access stratum message is associated with a non-access stratum termination point which does not correspond to the apparatus; and
select an appropriate network function supporting said non-access stratum termination point based at least in part on the received non-access stratum message.

7. The apparatus of claim 6, wherein the at least one memory and the computer program code are configured to, with the processing circuitry, further cause the apparatus at least to:
cause the appropriate network function to be provided with one or more non-access stratum security keys to be used for a non-access stratum security that is dedicated to the non-access stratum connection between the user device and the said non-access stratum termination point.

8. The apparatus of claim 7, wherein the at least one memory and the computer program code are configured to, with the processing circuitry, further cause the apparatus at least to:
in an instance in which one or more baseline non-access stratum keys have changed, cause the appropriate network function to be provided with the one or more updated security keys to be used for the non-access stratum security that is dedicated to the non-access stratum connection between the user device and the said non-access stratum termination point.

9. The apparatus of claim 7, wherein the at least one memory and the computer program code are configured to, with the processing circuitry, further cause the apparatus at least to:
cause the appropriate network function to be provided with one or more security keys corresponding to one or more baseline non-access stratum security keys

10. The apparatus of claim 1, wherein the non-access stratum termination point comprises an access and mobility management function or session management function.

11. The apparatus of claim 10, wherein the non-access stratum temporary identifier uniquely identifies an apparatus set in which all apparatus in the apparatus set have access to the same context associated with the non-access stratum termination point.

12. The apparatus of claim 10, wherein the non-access stratum temporary identifier identifies a specific apparatus in the apparatus set.

13. The apparatus of claim 10, wherein the non-access stratum temporary identifier identifies a group of apparatus sets.

14. An apparatus comprising:
processing circuitry including at least one processor; and
at least one memory including computer program code,
the at least one memory and the computer program code configured to, with the processing circuitry, cause the apparatus at least to:
receive a non-access stratum message from a user device, wherein the non-access stratum message is associated with a non-access stratum message container and the user device includes the non-access stratum container type either as part of the non-access stratum temporary identifier or as a separate information element;
determine an appropriate network function for the non-access stratum message based at least in part on an associated non-access stratum message container; and
cause the non-access stratum message to be provided to the appropriate network function.

15. The apparatus of claim 14, wherein:
the non-access stratum message container includes a non-access stratum temporary identifier, and
determination of the appropriate network function is based at least in part on the non-access stratum temporary identifier or the type of the non-access stratum container.

16. The apparatus of claim 14, wherein:
the non-access stratum message container includes a data network name and single network slice selection assistance information, and
determination of the appropriate network function is based at least in part on the data network name and the single network slice selection assistance information.

17. The apparatus of claim 14, wherein the at least one memory and the computer program code are configured to, with the processing circuitry, further cause the apparatus at least to:
query a database or a network repository function to determine the appropriate network function for the non-access-stratum message.

18. The apparatus of claim 16, wherein:
the appropriate network function comprises a subset of a core network function set, and
the non-access stratum temporary identifier or the non-access stratum message container includes at least one of an indication of a core network function instance or a core network function set.

19. An apparatus comprising:
processing circuitry including at least one processor; and
at least one memory including computer program code,
the at least one memory and the computer program code configured to, with the processing circuitry, cause the apparatus at least to:
receive one or more non-access stratum temporary identifiers from one or more network entities, wherein each non-access stratum temporary identifier or non-access stratum container type is indicative of a non-access stratum termination point; and
cause the one or more non-access stratum temporary identifiers and non-access stratum container types to be stored.

20. The apparatus of claim 19, wherein the at least one memory and the computer program code are configured to, with the processing circuitry, further cause the apparatus at least to:
cause one of the one or more stored non-access stratum temporary identifiers to be provided in a non-access stratum message.

21.-26. (canceled)
